(19) United States
(12) Patent Application Publication
(10) Pub. No.: US 2015/0154257 A1
(43) Pub. Date: Jun. 4, 2015

(54) System and method for adaptive query plan selection in distributed relational database management system based on software-defined network

(71) Applicant: NEC Laboratories America, Inc., Princeton, NJ (US)

(72) Inventors: Pengcheng Xiong, Burlingame, CA (US); Vahit Hakan Hacigumus, San Jose, CA (US)

(21) Appl. No.: 14/554,719

(22) Filed: Nov. 26, 2014

Related U.S. Application Data
(60) Provisional application No. 61/911,545, filed on Dec. 4, 2013.

(51) Int. Cl. G06F 17/30; H04L 12/26

(52) U.S. Cl. CPC G06F 17/30463; H04L 43/08

(57) ABSTRACT

Systems and methods are disclosed for selecting a query plan in a database by monitoring network state information and flow information; and selecting an adaptive plan for execution with a query manager that receives the network state information and flow information, including: receiving a query, parsing the query, generating and optimizing a global query plan; dividing the global query plan into local plans; sending the local plans to corresponding data store sites for execution with separate threads; and orchestrating data flows among the data store sites and forwarding a final result to a user.

This application claims priority to Provisional Application 61/911,545 filed Dec. 4, 2013, the content of which is incorporated by reference.

### BACKGROUND

To become more efficient, effective, and competitive, enterprises are expecting ever increasing benefits from data analytics. To meet this demand, data analytics platforms are including more data sources, which may be both internally and externally available. These data sources are often stored in distributed data stores. Data analytics applications or data scientists query the data from these distributed stores and merge and join the data to generate coherent analysis reports. With continuously increasing data sizes, querying and joining data from distributed sources can generate a significant amount of data traffic on the network, an issue that is exacerbated if the network is shared with other applications as well. Therefore, optimizing queries that access the distributed data stores, and specifically optimizing their network utilization, is likely to be an important problem to address in order to deliver improved query performance and query service differentiation.

Distributed data processing is supported by products from almost all major database system vendors nowadays. However, for decades, network has always been a major concern for performance management of distributed relational databases. Distributed queries suffer from bad performance in terms of query execution time when they encounter network resource contention. The main cause is due to the fact that a distributed query optimizer treats the underneath network as a black-box: it is unable to monitor it. Therefore, a traditional distributed query optimizer may select a bad query execution plan without dynamic network resource usage information.

In the past, people in database community expend considerable effort to work around the network rather than work with the network. For example, most of the distributed query optimizers consider the underneath network as a black-box and assume a constant parameter for the available network bandwidth. Some of the distributed query optimizers select and execute the plan that has the least cost albeit the network condition changes overtime. Although other distributed query optimizers make efforts to react to expected delays by scrambling, the decisions in their algorithm are either heuristic-driven which is prone to making poor scrambling decisions in some cases or inaccurate due to poor state of estimation for remote date access.

### SUMMARY

In one aspect, systems and methods are disclosed for selecting a query plan in a database by monitoring network state information and flow information; and selecting an adaptive plan for execution with a query manager that receives the network state information and flow information, including: receiving a query, parsing the query, generating and optimizing a global query plan; dividing the global query plan into local plans; sending the local plans to corresponding data store sites for execution with separate threads; and orchestrating data flows among the data store sites and forwarding a final result to a user.

Implementations of the method can include one or more of the following.

1. Creating a monitoring framework for collecting the current network bandwidth usage information.

2. Creating a cost model as a function of the available network bandwidth for distributed query plans in relational distributed databases.

3. Creating a query optimizer in relational distributed databases to adaptively select the best query plan with the shortest query execution time.

Advantages of the system may include one or more of the following. The system provides better performance: because the query optimizer will select the best query plan adaptively according to the dynamic network resource usage, query execution time is shorter. With greater visibility into the network's state, a distributed query optimizer could make more accurate cost estimates for different query plans and make better informed decisions. Moreover, as the optimizer could have some control of the network's future state, a distributed query optimizer could request and reserve the network bandwidth for a specific query plan and thereby improve query performance and query service differentiation.

### BRIEF DESCRIPTION OF THE DRAWINGS

FIG. 1 shows an exemplary network monitoring process.

FIG. 2 shows an exemplary adaptive plan selection process.

FIG. 3 shows an exemplary method for adaptive query plan selection in distributed relational database management system based on software-defined network.

FIG. 4 shows an exemplary system for adaptive query plan selection in distributed relational database management system based on software-defined network.

### DESCRIPTION

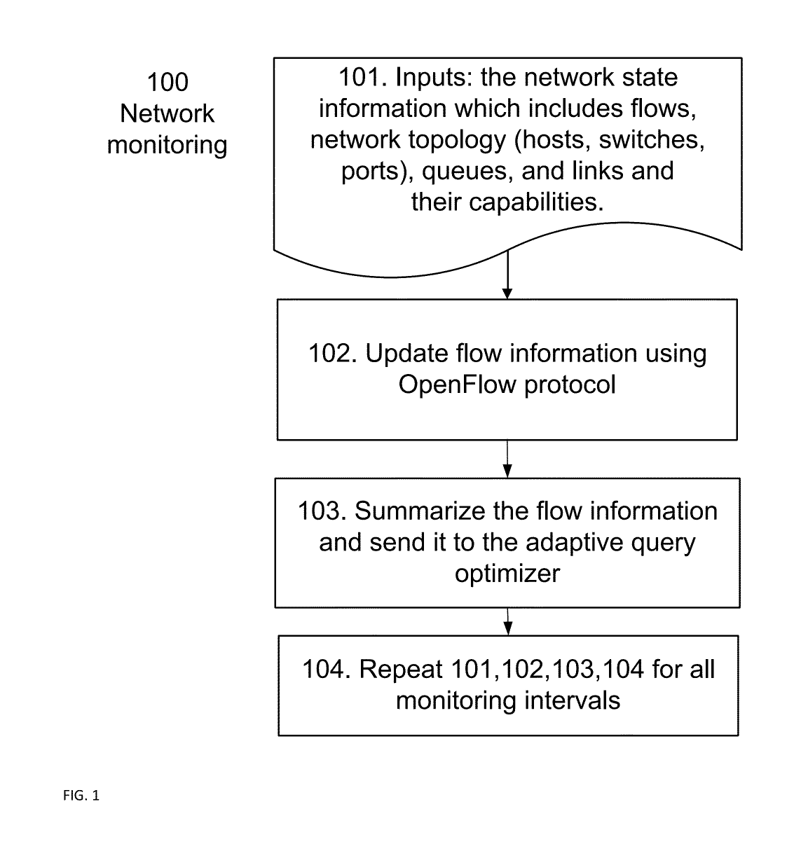

FIGS. 1-4 show a system that works with software-defined networking (SDN) and enables a distributed query optimizer to achieve such visibility into and control of the network's state. Given dynamic network bandwidth usage information which is provided by software-defined network, the system how to select the best query plan among candidate query execution plans which can offer the shortest query execution time.

By decoupling the system that makes decisions about where traffic is sent (the control plane) from the underlying systems that forward traffic to the selected destination (the data plane), network services can be managed through an abstraction of lower level functionality. Thus, SDN raises the possibility that it is for the first time feasible and practical for distributed query optimizers to carefully monitor and even control the network. Our goal in this paper is to begin the exploration of this capability, and to try to gain insight into whether it really is a promising new development for distributed query optimization. SDN can indeed be effectively exploited for the performance management of analytical queries in distributed data store environments. Our system can analyze and show the opportunities SDN provides for distributed query optimization.

The system adaptively selects the optimal query plan based on the information provided by the network before the query execution. This method observes the status of the network and reacts by adapting the query execution plan to one that yields better performance.

A distributed query processor can be used to deliver differentiated query service to the users with different priorities. One method allows for network traffic prioritization and the second method provides the capability of reserving a certain amount of bandwidth for specific queries and making use of that guaranteed bandwidth during query optimization. These methods achieve run-time query service differentiation in shared and highly utilized networks, which was not possible before.

A method to model dynamic communication costs is used. We integrate the model into a distributed query optimizer along with an existing computational cost model and show its effectiveness.

In one embodiment, a distributed data store environment is built using multiple instances of open source databases running on an SDN network with commercial OpenFlow enabled switches. Experimental results confirm our expectations and clearly show the benefits of the SDN technologies.

FIG. 1 shows an exemplary network monitoring process. The process receives as input the network state information including flows, network topology (hosts, switches, ports), queues, links and their capabilities (101). The process updates flow information (in one embodiment using OpenFlow protocol) (102). The flow information is summarized and sent to an adaptive optimizer (103). Operations 101-104 are repeated for all monitoring intervals (104).

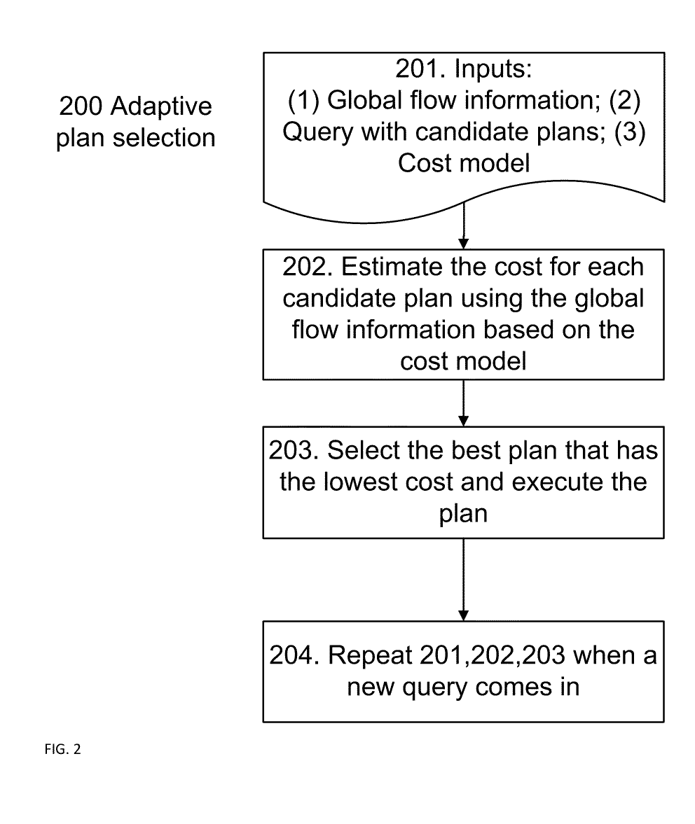

FIG. 2 shows an exemplary adaptive plan selection process. In 201, the process receives as inputs global flow information, query with candidate plans, and cost models. In 202, the process estimates the cost for each candidate plan using the global flow information based on the cost model. In 203, the process selects the best plan that has the lowest cost and executes the plan. In 204, operations 201-203 are repeated for each incoming queries.

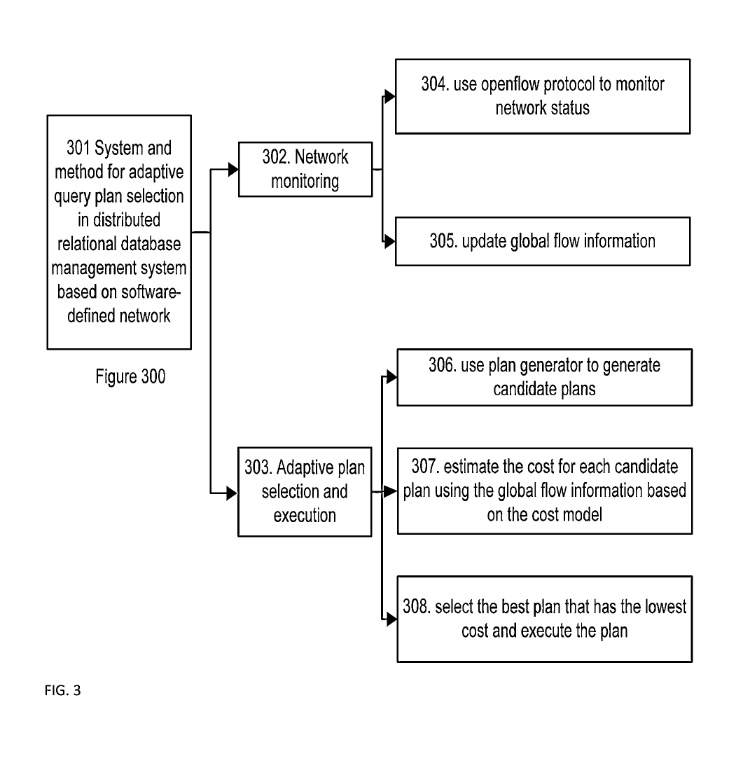

FIG. 3 shows an exemplary method 300 for adaptive query plan selection in distributed relational database management system based on software-defined network. The first step is the monitoring process. It monitors all the traffic of the flows in the openflow switches based on openflow protocol.

The second step is the adaptive plan selection. Here we propose a cost model to calculate the cost for a candidate plan based on the network status. And, based on the cost, the best plan that has the lowest cost is selected and executed.

The first part is network monitoring 302 which uses open flow protocol to monitor network status in 304 and updates global status in 305. In 304, the system uses openflow protocol to monitor network status. Before software-defined network is invented, network is treated as a black-box and it is impossible to observe network status in prior art. The second part is an adaptive plan selection and execution in 303. The operation 303 uses the plan generator to generate candidate plans in 306. Operation 303 then estimates the cost for each candidate plan using the global flow information based on the cost model in 307 and then selects the best plan with the lowest cost and executes the plan in 308.

In 307, the system uses cost model which is able to estimate the cost for a candidate plan using the global flow information. Previous work assumes that network cost is a fixed parameter. As a result, each candidate plan also has a fixed cost. In 308, the system adaptively selects the best plan that has the lowest cost from all the candidate plans. Previous work assumes a static best plan based on the cost calculation.

We have the following considerations: (1) Relational and SQL: For concreteness and the simplicity of the presentation, we assume in this paper that the stores are relational databases and that SQL is used to query the databases. (2) Analytical workloads: We consider data intensive analytical workloads as we expect that they are the most likely to benefit from the SDN technologies due to their heavy use of the interconnection network. (Transactional systems are unlikely to consume prolonged, high network bandwidth, as queries are typically very short and involve smaller amounts of data transfer.) Continuing this observation, the queries we consider are mostly read-only, consuming large amounts of network bandwidth. (3) Shared network: We also observe that many data analytics applications run on shared networks along with other applications that use the same network, sometimes competing for the network resources, which is consistent with many real world scenarios.

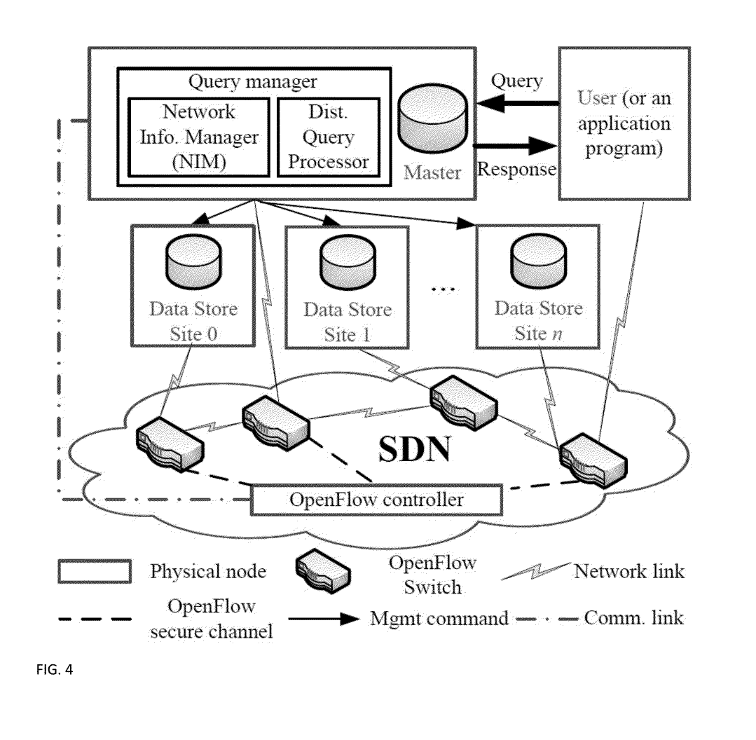

FIG. 4 shows the overall system architecture. The evaluation system is mainly composed of a user site, a master site, several data store sites, and an SDN component, which consists of an OpenFlow controller and OpenFlow switches. The unit of distribution in the system is a table and each table is either stored at one data store or can be replicated to more than one data stores. A user or application program submits the query to the master site for compilation. The master site coordinates the optimization of all SQL statements. We assume that only the data store sites store the tables. The master and the data stores run off-the-shelf, modified database servers (PostgreSQL, in our case). A query manager runs on the master site, which consists of a distributed query processor and a network information manager (NIM). The distributed query processor presents an SQL API to users. It also maintains a global view of the meta-data for all the tables in the databases. The query manager communicates with the OpenFlow controller to (1) receive network resource usage information, and update the information in NIM accordingly; and (2) send the control commands to the OpenFlow controller.

The basic operation of the system is as follows: when the query manager receives a query, it parses the query, generates, and optimizes a global query plan. The global query plan is divided into local plans. The local plans are sent to corresponding data store sites for execution via separate threads. The query manager orchestrates the necessary data flows among the data store sites. The query manager also forwards the final results from the master to the user.

In order to keep the programming simple, how data is stored and accessed via the network should be transparent to users. We map the table names used by the users, which we call the print names, to internal System Wide Names, SWN. An SWN has the form T^{S} which denotes that a copy of table T is stored at site S. For convenience, if there is a single copy of table T, we also denote the site that has this copy as S_{T}. The system uses a distributed catalog. The catalogs at each data store site maintain the information about the tables in the database, including the replicas stored at that site. The catalog at the master site keeps the information indicating where each table is currently stored and this entry is updated if a table is moved.

After name resolution, a set of candidate plans P are generated. Each plan is a tree such that each node of the tree is a physical operator, such as a sequential scan, sort, or hash join. A physical operator can be either blocking or nonblocking. An operator is blocking if it cannot produce any output tuples without reading all of its input. For instance, the sort operator is a blocking operator.

There are two cost models that can be used to estimate the cost of a plan. The classic cost model, which estimates the total resource consumption of a query, is useful for maximizing the overall throughput of a system. The response time model, which estimates the total response time of a query, is useful for minimizing query execution time. We use the response time model in this paper.

The optimizer estimates query execution cost by aggregating the cost estimates of the operators in the query plan. To distinguish blocking and non-blocking operators, this cost model considers both the start_cost and total_cost of each operator: start_cost (sc) is the cost before the operator can produce its first output tuple; total_cost (tc) is the cost after the operator generates all of its output tuples. Note that the cost of an operator includes the cost of its child operators. The run_cost (rc) is defined as rc=tc−sc. The total cost of a query plan P, denoted as Cₚ, is the total_cost of the root operator.

There are generally two kinds of operators in a distributed query execution plan, (1) local operators, O_{L}, which do not involve shipping data over the network; and (2) network operators, O_{N}, which do involve data shipping over the network. For example, in FIG. 3(b), the scan, hash, and hashjoin operators are local operators, while the function scan (func_scan) operator is a network operator.

Based on the cost models of local and network operators, we summarize how we estimate the cost Cₚ for a plan P as follows. Here each brace means a dependency relationship.

$${C}_{P} \{ \begin{matrix}{C}_{{O}_{L}} ( Sec . ) \\ {C}_{{O}_{N}} \{ \begin{matrix}{D}_{{O}_{N}} ( Sec . ) \\ {C ( U )}_{{O}_{N}} \{ \begin{matrix}{UB}_{{O}_{N}} ( Sec . ) \\ {A ( U )}_{{O}_{N}} \{ \begin{matrix}Flow . rate ( Sec . ) \\ {R ( U )}_{{O}_{N}} ( Sec . )\end{matrix}\end{matrix}\end{matrix}\end{matrix}$$

The cost Cₚ for a plan P depends on the cost of operators O_{L} and O_{N}, denoted as C_{O}_{_{L}} and C_{O}_{_{N}}, respectively. C_{O}_{_{N}} depends on the amount of data transferred by O_{N}, denoted as D_{O}_{_{N}}, and the data transfer rate, i.e., real-time bandwidth consumption for O_{N} denoted as C(U)_{O}_{_{N}}. C(U)_{O}_{_{N}} further depends on the upper bound bandwidth consumption for O_{N} (i.e., UB_{O}_{_{N}}), the available bandwidth for user U for O_{N} (i.e., A(U)_{O}_{_{N}}), and the reserved bandwidth for O_{N} by user U. Generally speaking, we define a network traffic matrix as a |S|×|S| matrix where |S| is the total number of sites. The rows of the matrix correspond to the source sites while the columns correspond to the destination sites. Cap denotes the port capacity, which is a constant 1 Gbps in our setting, and all the elements in the matrix should be less than Cap. The available bandwidth matrix for user U is a network traffic matrix, denoted as A(U). If we assume that network operator O_{N} involves data shipping from S_{src} to S_{dst}, then the available bandwidth for O_{N}, denoted as A(U)_{O}_{_{N}} is the value at row S_{src} and column S_{dst} of A(U).

Compared with a traditional distributed query optimizer and executor, the query optimizer and executor in our system have the following distinguishing features:

1. A traditional distributed query optimizer generally models the network as a FIFO queue with a constant bandwidth. However, because the total cost Cₚ depends on A(U) in our system, our optimizer can adapt to the dynamic network status when choosing the best plan.

2. In traditional distributed query processing, once the best query plan is selected, it will be executed. If many lower priority queries are saturating the network, a traditional distributed query processing can do nothing to expedite an incoming important query. However, our query optimizer can “protect” the important queries by either giving them higher priority to use network bandwidth than the lower priority queries or by reserving and using the reserved network bandwidth.

SDN is an approach to networking that decouples the control plane from the data plane. The control plane is responsible for making decisions about where traffic is sent, while the data plane forwards traffic to the selected destination. This separation allows network administrators and application programs to manage network services through abstraction of lower level functionality by using software APIs. From a DBMS point of view, the abstraction and the control APIs allow the DBMS to (1) inquire about the current status and performance of the network, and (2) control the network with directives, for example, with bandwidth reservations.

OpenFlow is a standard communication interface among the layers of an SDN architecture, which can be thought of as an enabler for SDN. An OpenFlow controller communicates with an OpenFlow switch. An OpenFlow switch maintains a flow table, with each entry defining a flow as a certain set of packets by matching on 10 tuple packet information. When a new flow arrives, according to the OpenFlow protocol, a “PacketIn” message is sent from the switch to the controller. The first packet of the flow is delivered to the controller. The controller looks into the 10 tuple packet information, determines the egress (exiting) port and sends a “FlowMod” message to the switch to modify a switch flow table. More specifically, APIs in the OpenFlow switch enable us to attach the new flow to one of the physical transmitter queues behind each port of the switch. When an existing flow times out, according to OpenFlow protocol, a “FlowRemoved” message is delivered from the switch to the controller to indicate that a flow has been removed. There are already OpenFlow controllers and switches that implement the OpenFlow standard from the major vendors in the industry. In our studies we also use actual commercial products from one of those vendors, NEC.

For example, we show a commercial OpenFlow switch NEC PFS5240 and three data store sites S_{0,1,2} connected to the switch at port 0,1,2 in FIG. 4. There is a receiver and a transmitter behind each port of the switch and there are 8 transmission queues q8 to q1 inside a transmitter. When a new flow Flow₀ (from S₀ to S₂) under user U's name arrives, a “PacketIn” message is sent from the switch to the controller. The controller looks into the 10 tuple packet information, determines the egress ports (i.e., 2) and one of the transmission queues (e.g., q8) according to the user's priority Uₚᵣᵢ and sends a “FlowMod” message to the switch to modify a switch flow table. The following packets in the same flow will be sent through the same transmission queue q8 of the egress ports (i.e., 2) to site S₂. If no user information is specified, a default queue (q4) will be used.

The OpenFlow API is used to implement our performance management methods. The network information manager (NIM) updates and inquires information about the current network state by communicating with the OpenFlow controller. The network information includes the network topology (hosts, switches, ports), queues, and links, and their capabilities. The runtime uses the information to translate the logical actions to a physical configuration, and to host the switch information such as its ports' speeds, configurations, and statistics. It is important to keep this information up-to-date with the current state of the network as an inconsistency could lead to under-utilization of network resources as well as bad query performance. In the NIM, we define a Flow as a four tuple:
Flow::=[src,dst,queue,rate]

Here src and dst mean the ingress and egress ports of the switch for the flow, respectively. queue means the egress queue of the flow, and rate means the traffic rate. For example, we can have two flows, Flow₀=[0, 2, q8, 200 Mbps] and Flow₁=[1, 2, q1, 200 Mbps] as shown in FIG. 4. Flow₀ means that the flow is from port 0 (S₀) to q8 of port 2 (S₂) and the rate is 200 Mbps.

The distributed query processor sends an inquiry to the network information manager to inquire A(U)_{O}_{_{N}}, i.e., the available bandwidth for network operator O_{N} for user U. More specifically, it is calculated as

$${A ( U )}_{{O}_{N}} = Cap - {\sum }_{Flow . dst = {O}_{N} . dist} Flow . rate \qquad ( 1 )$$

Generally, we are interested in the flows that could compete with O_{N} at the transmitter. These flows should share the same destination port with O_{N}, i.e., Flow.dst=O_{N}.dst. We sum up all these flows and the remaining bandwidth is assumed to be the available bandwidth for O_{N}. Note that A(U)_{O}_{_{N}} as calculated by the above formula is a very rough estimation of the available bandwidth for O_{N} as there are various factors that we do not take into consideration, e.g., interaction between different flows with different internet protocols UDP and TCP.

For example, assume that we have two flows, Flow₀ and Flow₁, and a network operator O_{N}. O_{N}'s destination port is also port 2 and O_{N} uses the default queue q4 as shown in FIG. 4. Because there is no defined network traffic differentiation at this moment, all the queues q8, q4, q1 have the same priority. Then A(U)_{O}_{_{N}}=1G−(200M+200M)=624 Mbps.

Our distributed query processor can communicate with the OpenFlow controller to leverage the OpenFlow APIs to pro-actively notify the switch to give certain priority to or make a reservation for specific flows. The main mechanism in the OpenFlow switch to implement these methods is the transmission queues. We show two examples using a priority queue (PQ) and a weighted fair queue (WFQ) in our system while the other options could also be possible. For example, combining PQ and WFQ could be considered to resolve more difficult network resource contention situations, which could be a future work.

In this case, we set the queues within the switch as priority queues (PQ). If more than one queue has queued frames, PQ sends frames in the order of queue priority. During the transmission, this configuration gives higher-priority queues absolute preferential treatment over lower-priority queues. If any port is set as PQ, then the queues from the highest priority to the lowest priority are q8, q7, . . . , q1. Under this setting, the calculation of the available bandwidth for O_{N} should be changed accordingly:

$${A ( U )}_{{O}_{N}} = Cap - {\sum }_{Flow . dst = {O}_{N} . dst ⋀ Flow . queue . pri \geq U . pri} Flow . rate \qquad ( 2 )$$

Here Flow.queue.pri means the priority of queue and U.pri means the priority of user U (O_{N}'s priority is the same as the user's priority who submits the query). Compared with (1), besides sharing the same destination port with O_{N}, the competing flows should have equal or higher priority than O_{N}, i.e., Flow.queue.pri≧U.pri.

For example, assume that we have two flows, Flow₀ and Flow₁, and a network operator O_{N} as shown in FIG. 4. O_{N}'s destination port is also port 2 and O_{N} is assigned by OpenFlow controller to use queue q4 according to the user U's priority. Because q4 has higher priority than q1 and lower priority than q8, only Flow₀ will compete with O_{N}. Thus, A(U)_{O}_{_{N}}=1 G−200M=824 Mbps. We can see that the available bandwidth for O_{N} is 200 Mbps more than the case when no network traffic differentiation is applied (624 Mbps). Because the cost of O_{N} depends on A(U)_{O}_{_{N}}, the distributed query optimizer selects the query plan accordingly.

In this case, we set the port within the switch as weighted fair queues. After setting the weight (minimum guaranteed bandwidth) on every queue, the switch sends the amount of frames equivalent to the minimum guaranteed bandwidth from each queue to begin with. Under this setting, the calculation of the available bandwidth for O_{N} should be changed accordingly:

$${A ( U )}_{{O}_{N}} = Max ( Cap - {\sum }_{Flow . dst = {O}_{N} . dist} Flow . rate , {R ( U )}_{{O}_{N}} )$$

Here R(U)_{O}_{_{N}} is the bandwidth reservation for O_{N} by user U. For example, assume that we have two flows, Flow₀ and Flow₁, and a network operator O_{N} as shown in FIG. 4. We assume that the user makes an 800 Mbps bandwidth reservation for O_{N} and the other users do not make any bandwidth reservations. By calculation, A(U)_{O}_{_{N}} is equal to the bandwidth reservation (i.e., 800 Mbps). We can see that the available bandwidth for O_{N} is more than the case when no network traffic differentiation is applied (624 Mbps). Similar to the previous cases, this method computes A(U)_{O}_{_{N}} value, which affects the cost of O_{N}, and in turn, the plan selection of the distributed query optimizer. Note that WFQ works in a work conserving mode in this switch. That is, although O_{N} is guaranteed 800 Mbps, if O_{N} does not use 800 Mbps, the other flow can use the remaining bandwidth. If O_{N} indeed uses the capacity and also the other flows also use up the maximum capacity, the system guarantees the reserved capacity for O_{N} and serves the other flows with the remaining capacity by throttling them as necessary.

The system leverages software-defined networking for the performance management of analytical queries in distributed data stores in a shared networking environment. The system utilizes greater visibility into the network's state and makes more informed decisions to adaptively pick the best plan. The system can control the priority of network traffic or make network bandwidth reservations according to different users' priorities, thereby differentiating the query service. The instant methods exhibit significant potential for the performance management of analytical queries in distributed data stores. The system enhances distributed data intensive computing by combing SDN and distributed database technologies.

While the foregoing is directed to embodiments of the present invention, other and further embodiments of the invention may be devised without departing from the basic scope thereof, and the scope thereof is determined by the claims that follow.

What is claimed is:

1. A method for selecting a query plan in a database, comprising
monitoring network state information and flow information; and
selecting an adaptive plan for execution with a query manager that receives the network state information and flow information, including:
receiving a query, parsing the query, generating and optimizing a global query plan;
dividing the global query plan into local plans;
sending the local plans to corresponding data store sites for execution with separate threads;
orchestrating data flows among the data store sites and forwarding a final result to a user.

2. The method of claim 1, wherein the network monitoring comprises using the OpenFlow protocol to monitor network status.

3. The method of claim 1, wherein the network monitoring comprises updating global flow information.

4. The method of claim 1, wherein the selecting of the adaptive plan comprises using a plan generator to generate candidate plans.

5. The method of claim 1, wherein the selecting of the adaptive plan comprises estimating a cost of each candidate plan using a global flow of information based on a cost model.

6. The method of claim 5, comprising estimating the cost for a candidate plan using the global flow information and the cost model.

7. The method of claim 1, wherein the selecting of the adaptive plan comprises selecting the best plan with the lowest cost, comprising executing the selected plan.

8. The method of claim 1, comprising generating a dynamic communication cost model.

9. The method of claim 8, comprising integrating the dynamic communication costs with a computational cost model.

10. The method of claim 1, comprising delivering differentiated query service to users with different priorities.

11. The method of claim 1, comprising performing network traffic prioritization.

12. The method of claim 1, comprising setting queues within a switch as priority queues (PQ) and if more than one queue has queued frames, the PQ sends frames in order of queue priority and during the transmission, providing higher-priority queues absolute preferential treatment over lower-priority queues.

13. The method of claim 1, wherein a network information manager (NIM) updates and inquires information about a current network state by communicating with a flow controller, comprising storing flow as a four tuple including ingress and egress ports of a switch for the flow, an egress queue of the flow, and a traffic rate.

14. The method of claim 13, comprising
sending an inquiry to the NIM to inquire A(U)_{O}_{_{N}} (available bandwidth for network operator O_{N} for user U) determined as
$${A ( U )}_{{O}_{N}} = Cap - {\sum }_{Flow . dst = {O}_{N} . dist} Flow . rate$$
determining flows that compete with O_{N} at a transmitter and share the same destination port with O_{N}, so that Flow.dst=O_{N}.dst;
summing all flows and the remaining bandwidth is determined the available bandwidth for O_{N}.

15. The method of claim 1, comprising reserving a guaranteed bandwidth for a predetermined query and using guaranteed bandwidth during query optimization.

16. A database system, comprising:
a flow controller;
a plurality of data stores coupled to the flow controller; and
a distributed query processor with code to:
monitor network state information and flow information; and
select an adaptive plan for execution with a query manager that receives the network state information and flow information, including:
receive a query, parsing the query, generating and optimizing a global query plan;
divide the global query plan into local plans;
send the local plans to corresponding data store sites for execution with separate threads;
orchestrate data flows among the data store sites and forwarding a final result to a user.

17. The system of claim 16, wherein the distributed query processor delivers differentiated query service to the users with different priorities with two methods, one method allows for network traffic prioritization and the second method provides a capability of reserving a guaranteed bandwidth for specific queries and making use of that guaranteed bandwidth during query optimization, wherein the methods achieve run-time query service differentiation in shared and highly utilized networks.

18. The system of claim 16, comprising a module to model dynamic communication costs can be used, wherein the model is integrated into the distributed query optimizer along with a computational cost model.

19. The system of claim 16, wherein a network information manager (NIM) updates and inquires information about a current network state by communicating with a flow controller, comprising storing flow as a four tuple including ingress and egress ports of a switch for the flow, an egress queue of the flow, and a traffic rate.

20. The method of claim 19, comprising
sending an inquiry to the NIM to inquire A(U)_{O}_{_{N}} (available bandwidth for network operator O_{N} for user U) determined as
$${A ( U )}_{{O}_{N}} = Cap - {\sum }_{Flow . dst = {O}_{N} . dist} Flow . rate$$
determining flows that compete with O_{N} at a transmitter and share the same destination port with O_{N}, so that Flow.dst=O_{N}.dst;
summing all flows and the remaining bandwidth is determined the available bandwidth for O_{N}.
